(19) United States
(12) Patent Application Publication
(10) Pub. No.: US 2012/0231836 A1
(43) Pub. Date: Sep. 13, 2012

(54) METHOD AND APPARATUS TO AVOID IN-DEVICE COEXISTENCE INTERFERENCE IN A WIRELESS COMMUNICATION SYSTEM

(75) Inventors: Richard Lee-Chee Kuo, Taipei (TW); Li-Chih Tseng, Taipei (TW)

(73) Assignee: INNOVATIVE SONIC CORPORATION, Taipei (TW)

(21) Appl. No.: 13/414,003

(22) Filed: Mar. 7, 2012

Related U.S. Application Data
(60) Provisional application No. 61/450,023, filed on Mar. 7, 2011.

(51) Int. Cl. H04W 88/06

(52) U.S. Cl. 455/553.1

(57) ABSTRACT

A method and apparatus are disclosed for in-device coexistence interference detection. In one embodiment, the method comprises equipping a UE (user equipment) with a first radio based on LTE radio technology or LTE-advanced radio technology and a second radio based on another radio technology. The method also comprises activating the first radio and the second radio in the UE. Furthermore, the method comprises determining a presence of in-device coexistence interference from the second radio based on a transport block error rate (TBER) in the LTE radio technology or LTE-advanced radio technology.

### CROSS-REFERENCE TO RELATED APPLICATIONS

The present Application claims the benefit of U.S. Provisional Patent Application Ser. No. 61/450,023, filed on Mar. 7, 2011, the entire disclosure of which is incorporated herein by reference.

### FIELD

This disclosure generally relates to wireless communication networks, and more particularly, to a method and apparatus to avoid in-device coexistence interference in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for in-device coexistence interference detection. In one embodiment, the method comprises equipping a UE (user equipment) with a first radio based on LTE radio technology or LTE-advanced radio technology and a second radio based on another radio technology. The method also comprises activating the first radio and the second radio in the UE. Furthermore, the method comprises determining a presence of in-device coexistence interference from the second radio based on a transport block error rate (TBER) in the LTE radio technology or LTE-advanced radio technology.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram of an exemplary Time Division Multiplexing (TDM) pattern according to one exemplary embodiment.

FIG. 6 illustrates a time-based implementation of TBER calculation over a time period according to one exemplary embodiment.

FIG. 7 shows a number-based implementation of TBER calculation over a known number of transport blocks according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LIE-A or LTE-Advanced (Long Term Evolution Advanced), 3GPP2 UMB (Ultra Mobile Broadband), WiMax, or some other modulation techniques.

In particular, The exemplary wireless communication systems devices described below may be designed to support one or more standards such as the standard offered by a consortium named “3rd Generation Partnership Project” referred to herein as 3GPP, including Document Nos. TR 36.816 V1.0.0, “Study on signalling and procedure for interference avoidance for in-device coexistence (Release 10)”; TS 36.331 v10.0.0, “RRC protocol specification (Release 10)”; R2-111274, “Relevance of measurement as trigger to indicate ISM interference to eNB”; RAN2 meeting notes 25 Feb. 1700 (for RAN24#3); and TS 36.321 v.10.0.0, “MAC protocol specification (Release 10)”. The standards and documents listed above are hereby expressly incorporated herein.

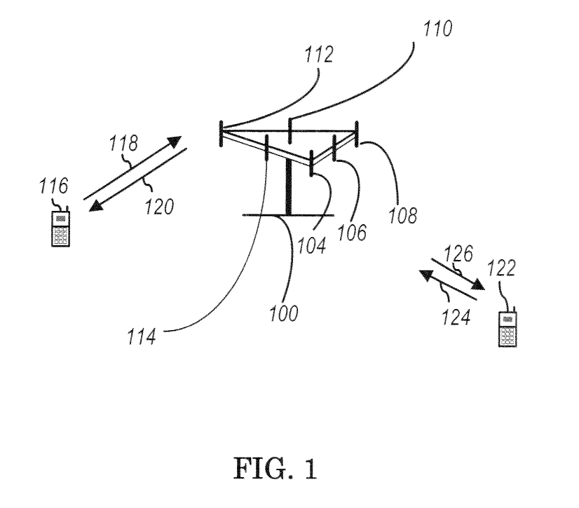

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

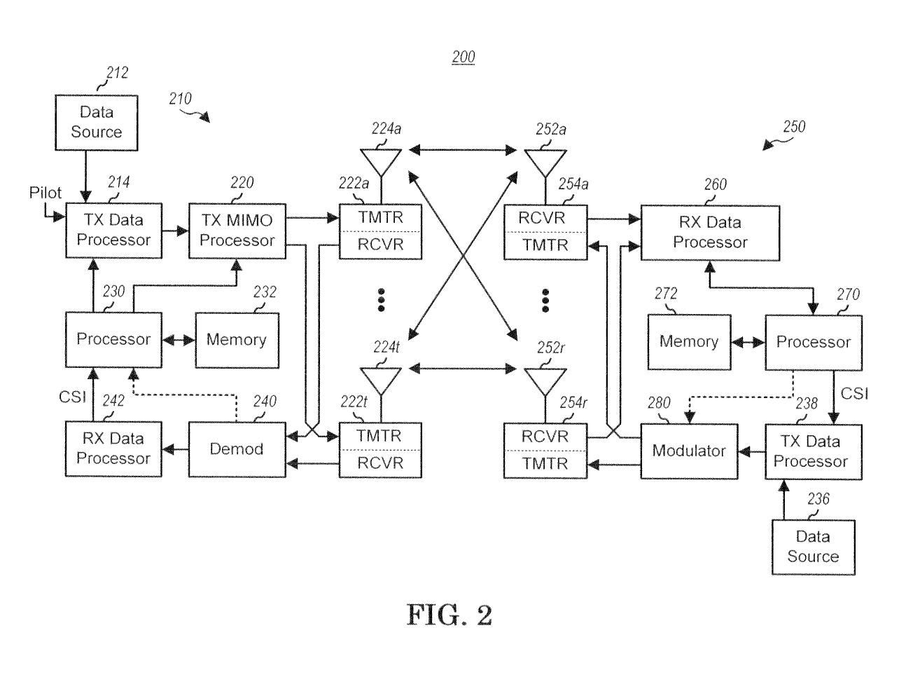

FIG. 2 is a simplified block diagram of an embodiment of a transmitter system 210 also known as the access network) and a receiver system 250 also known as access terminal (AT) or user equipment (UT)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g. for OFDM). TX MIMO processor 220 then pros/ides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g. amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding, the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

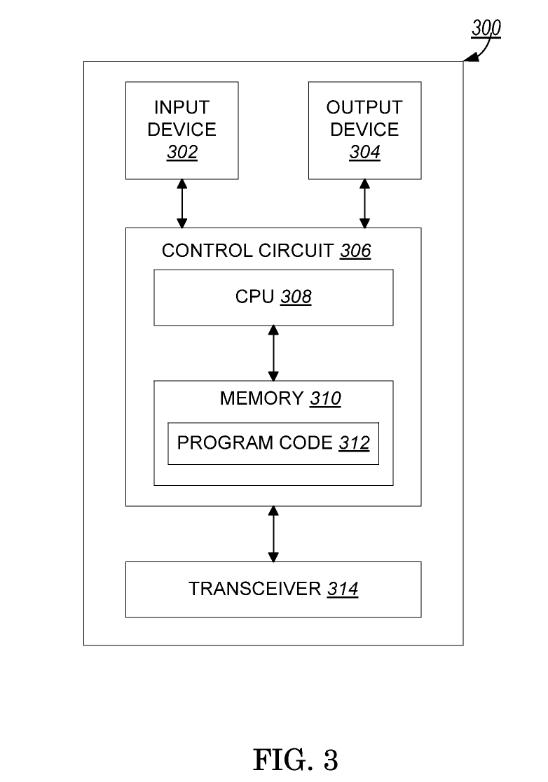

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LIE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

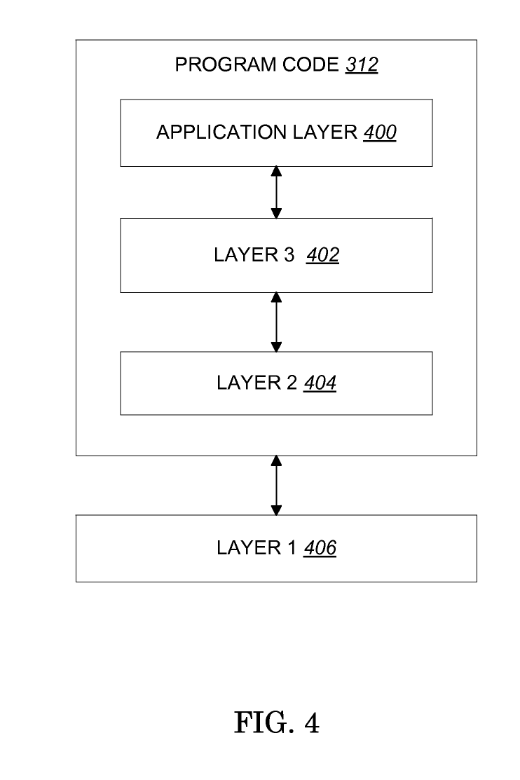

FIG. 4 is a simplified block diagram or the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In order to allow users to access various networks and services ubiquitously, an increasing number of UEs are equipped with multiple radio transceivers. For example, a UE may be equipped with LTE, WiFi, Bluetooth transceivers, and Global Navigation Satellite System (GNSS) receivers. One resulting challenge lies in trying to avoid coexistence interference between those collocated radio transceivers. A study item was created to address the challenge or issue. 3GPP TR 36.816 v1.0.0 generally captures the issue as follows:

2.46 Hz ISM band is currently allocated for WiFi and Bluetooth channels.

3GPP frequency bands around 2.4 GHz ISM band includes Band 40 for TDD Mode and Band 7 UL for FDD mode.

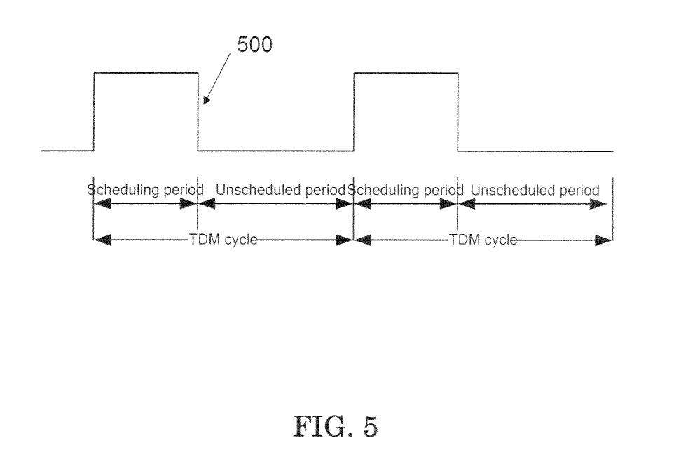

Frequency Division Multiplexing (FDM) solution and Time Division Multiplexing (TDM) solution are two potential solution directions for resolving the issue. FIG. 5 shows a TDM cycle having a scheduling period and an unscheduled period. Scheduling period is a period in the TDM cycle during which the LIE UE may be scheduled to transmit or receive as shown by the TDM pattern 500. Unscheduled period is a period during which the LTE UE is not scheduled to transmit or receive as shown by the TDM pattern 500, thereby allowing the ISM radio to operate without interference. Table 1 summarizes exemplary pattern requirements for main usage scenarios:

TABLE 1

| | | Unscheduled |
|---|---|---|
| Usage scenarios | Scheduling period (ms) | period (ms) |
| LTE + BT earphone | Less than [60] ms | Around [15-60] ms |
| (Multimedia service) | | |
| LTE + WiFi portable | No more than [20-60] ms | No more than |
| router | | [20-60] ms |
| LTE + WiFi offload | No more than [40-100] ms | No more than |
| | | [40-100] ms |

As discussed in 3GPP TR 36.816 v1.0.0. the DRX mechanism was adopted as a baseline for TDM solution. In the context of the DRX mechanism as baseline. LTE uplink transmission and downlink reception may generally be performed during an active time and are not allowed during an inactive time sleeping time).

In general, R2-111274 addresses the relevance of measurement as trigger to indicate ISM interference to eNB. More specifically, the two following observations can be drawn or extracted from R2-111274:

Observation 1: It is clear from the discussion above that if measurement is finalized as criteria to trigger the indication to inform eNB that UE is suffering from ISM then it will not be useful in many cases.
Observation 2: Measurement as criteria for trigger to inform in-device co-existence issue to eNB has potential to make UE silently suffer from ISM as measurement values might be good but packets are corrupted.

The above observations seem to imply that the current RRM measurement is not suitable to be a trigger to indicate ISM interference to eNB. Thus, R2-111274 raises the following proposal:

Proposal 1: Based on observations 1, 2, 3, 4 we propose that relevance of measurement as trigger to indicate ISM interference to eNB is low. It is better to keep trigger as UE implementation.

The following points were discussed in RAN2#73 meeting:

Existing RRM measurement cannot be used to guarantee timely trigger.

FFS to WI phase how to limit unnecessary triggers/trigger misuse e.g. by defining new measurements or new test cases: can be left to RAN4.

As a result, since a trigger of ISM interference may cause eNB to initiate either a FDM solution (such as an inter-frequency handover) or a TDM solution, an unnecessary trigger would induce unnecessary handover procedure or degrade LTE throughput. Thus, unnecessary triggers should be avoided (e.g. by defining a new way for a UE to determine whether ISM interference is present or not.)

According to R2-111274, one Win transmission could overlap with about 4 LTE OFDM symbols and there are 14 OFDM symbols in one LIE subframe. Thus, when a collision occurs in a subframe, the transport block (TB) received in this subframe will be corrupted (i.e., the TB will not be decoded successfully). If transport block errors occur often, it may imply the in-device coexistence interference is serious. For example, a big transport block error rate (TBER) may reflect the presence of in-device coexistence interference in a UE. Therefore, it should be feasible for a UE to determine the presence of in-device coexistence interference based on a downlink TBER calculated over a time period or over certain number of recently received transport blocks (e.g., 1000 transport blocks).

The UE may determine the presence of in-device coexistence interference if the TBER is greater than a threshold. In one embodiment, the threshold could be a predefined value. In an alternative embodiment, the threshold could be configured by the eNB. A low TBER should be endurable even if the in-device coexistence interference does exist. Furthermore, CRC checking to determine whether an error occurs to a received transport block may be done either before or after combining the transport block with the previous data stored in the soft buffer corresponding to the transport block. In one embodiment, the transport blocks are received on a Physical Downlink Shared Channel (PDSCH). In another embodiment, the CRC associated with a transport block is carried on a Physical Downlink Control Channel (PDCCH) signaling the downlink assignment of the transport block. After determining the presence of the in-device coexistence interference, the UE would send an indication to the eNB.

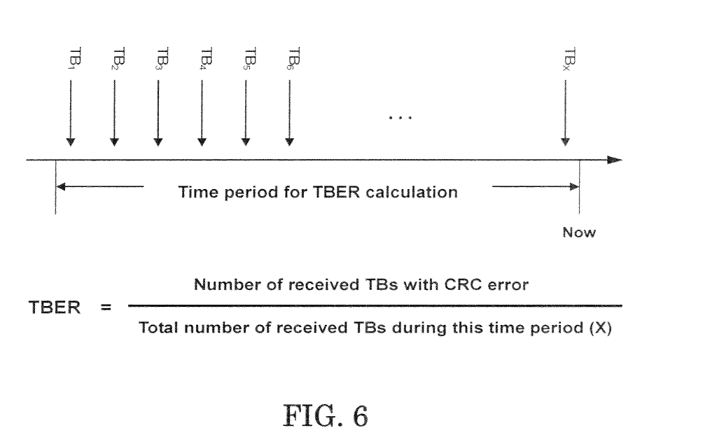

FIG. 6 illustrates an exemplary time-based implementation of TBER calculation over a time period. In one embodiment, the time period could be a predefined or preset value. In an alternative embodiment, the time period could be configured by the eNB. By way of example, if the total number of received TBs during this time period is represented by X and CRC error occurs to certain TBs among X received TBs, the TBER would be equal to the number of received TBs with CRC error divided by the total number (X) of TBs received during the time period.

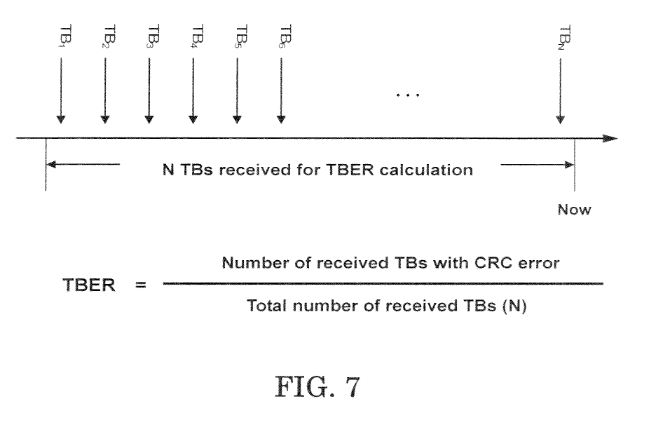

FIG. 7 shows an alternative exemplary number-based implementation of TBER calculation over a known number of received transport blocks (TBs). In one embodiment, the number of received transport blocks could be a predefined or preset value. In an alternative embodiment, the number of received transport blocks could be configured by the eNB. For example, if the TBER is calculated after a known number (N) of TBs are received and CRC error occurs to certain TBs among N received TBs, the TBER would be equal to the number of received TBs with CRC error divided by the total number of received TBs (N).

Since eNB may also be able to calculate the downlink transport block error rate (TBER) in a UE based on the HARQ ACK/NACK sent from the UE, it may be possible for the eNB to determine the presence of in-device coexistence interference in the UE based on the TBER. The eNB may determine the presence of in-device coexistence interference in the UE if the TBER is greater than a threshold. The activation status of other radio technology in the UE may also be taken into consideration. For example, the eNB may determine the presence of in-device coexistence interference based on the TBER if the other radio technology in the UE is activated.

In one embodiment, the eNB may calculate the TBER over a time period. By way of example, if the total number of transmitted TBs during this time period is represented by X and certain TBs among X transmitted TBs are associated with an HARQ (Hybrid Automatic Repeat and Request) NACK (Negative Acknowledgement) received from the UE, the TBER would be equal to the number of transmitted TBs with HARQ NACK divided by the total number (X) of TBs transmitted during the time period.

In another embodiment, the eNB may calculate the TBER over a known number of transmitted transport blocks (TBs). By way of example, if the TBER is calculated after a known number (N) of TBs are transmitted and certain TBs among N transmitted TBs are associated with an HARQ NACK received from the UE, the TBER would be equal to the number of transmitted TBs with HARQ NACK divided by the total number of transmitted TBs (N).

In addition, the transport blocks could be transmitted on a PDSCH (Physical Downlink Shared Channel). Furthermore, the HARQ NACK associated with the transmitted transport blocks could be received on a PUCCH (Physical Uplink Control Channel).

Referring back to FIGS. 3 and 4, the UE 300 includes a program code 312 stored in memory 310. In one embodiment, the UE 300 is equipped with a UE with a first radio based on LTE radio technology or LTE-Advance radio technology and a second radio based on an alternate radio technology. In this embodiment, the CPU 308 could execute the program code 312 to activate the first radio and the second radio in the UE, and to determine a presence of in-device coexistence interference from the second radio based on a transport block error rate (TBER) in the LIE radio technology or LTE-advanced radio technology. In addition, the CPU 308 could execute the program code 312 to perform a CRC check to determine whether an error occurs to a received transport block before combining the received transport block with previous data stored in a soft buffer corresponding to the received transport block. The CPU 308 could also execute the program code 312 to perform a CRC check to determine whether an error occurs to a received transport block after combining the received transport block with previous data stored in a soft buffer corresponding to the received transport block.

In an alternative embodiment, the CPU 308 can execute the program code 312 to establishing a RRC (Radio Resource Control) connection between an eNB (evolved Node B) and a LTE (user equipment), and determining a presence of in-device coexistence interference in the UE based on a downlink transport block error rate (TBER) in a LTE or LTE-Advanced radio technology. In this embodiment, the eNB determines the presence of in-device coexistence interference.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels May be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform t functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for in-device coexistence interference detection, comprising:
equipping a UE (user equipment) with a first radio based on LIE radio technology or LTE-advanced radio technology and a second radio based on another radio technology;
activating the first radio and the second radio in the UE; and
determining a presence of in-device coexistence interference from the second radio based on a transport block error rate (TBER) in the LIE radio technology or LIE-advanced radio technology.

2. The method of claim 1, wherein the UE determines the presence of in-device coexistence interference when a TBER is greater than a threshold.

3. The method of claim 2, wherein the threshold is predefined value.

4. The method of claim 2, wherein the threshold is configured by an eNB (evolved Node B).

5. The method of claim 1, wherein the TBER is calculated over a time period as a ratio of a number of transport blocks, which are among transport blocks that are received during the time period and that result in a CRC (Cyclic Redundancy Check) error, and a total number of the transport blocks received during the time period.

6. The method of claim 1, wherein the TBER is calculated over a number of transport blocks received from the UE as a ratio of a number of transport blocks, which are among the transport blocks that are received from the UE and that result in a CRC error, and a total number of the transport blocks received from the UE.

7. The method of claim 1, further comprises:
performing a CRC check to determine whether an error occurs a received transport block before combining the received transport block with previous data stored in a soft buffer corresponding to the received transport block.

8. The method of claim 1, further comprises:
performing a CRC check to determine whether an error occurs to a received transport block after combining the received transport block with previous data stored in a soft buffer corresponding to the received transport block.

9. The method of claim 1, wherein the second radio is based on an ISM (Industrial, Scientific and Medical) such as BlueTooth or WiFi (Wireless Fidelity).

10. A communication device for use in a wireless communication system, the communication device comprising:
a first radio based on LTE radio technology or LTE-Advanced radio technology and a second radio based on another radio technology;
a control circuit coupled to the first and second radios;
a processor installed in the control circuit;
a memory installed in the control circuit and coupled to the processor;
wherein the processor is configured to execute a program code stored in memory to perform a coexistence interference avoidance in the communication device by:
activating the first radio and the second radio in the UE; and
determining a presence of in-device coexistence interference from the second radio based on a transport block error rate (TBER) in the LTE radio technology or LTE-advanced radio technology.

11. A method for in-device coexistence interference detection, comprising:
establishing a RRC (Radio Resource Control) connection between an eNB (evolved Node B) and a UE (user equipment); and
determining a presence of in-device coexistence interference in the UE based on a downlink transport block error rate (TBER) in a LIE or LTE-Advanced radio technology.

12. The method of claim 11, wherein the eNB determines the presence of in-device coexistence interference in the UE if the TBER is greater than a threshold.

13. The method of claim 11, wherein the TBER is calculated over a time period as a ratio of a number of transport blocks, which are among transport blocks transmitted to the UE during the time period and are associated with an HARQ (Hybrid Automatic Repeat and Request) NACK (Negative Acknowledgement) received from the UE, and a total number of the transport blocks transmitted to the UE during the time period.

14. The method of claim 13, wherein the transport blocks are transmitted on a PDSCH (Physical Downlink Shared Channel).

15. The method of claim 13, wherein the HARQ (Hybrid Automatic Repeat and Request) NACK associated with the transmitted transport block is received on a PUCCH (Physical Uplink Control Channel).

16. The method of claim 11, wherein the TBER is calculated over a number of transport blocks transmitted to the UE as a ratio of a number of transport blocks, which are among the transport blocks transmitted to the UE and are associated with an HARQ (Hybrid Automatic Repeat and Request) NACK (Negative Acknowledgement) received from the UE, and a total number of the transport blocks transmitted to the UE.

17. The method of claim 16, wherein the transport blocks are transmitted a PDSCH (Physical Downlink Shared Channel).

18. The method of claim 16, wherein the HARQ (Hybrid Automatic Repeat and Request) NACK associated with the transmitted transport block is received on a PUCCH (Physical Uplink Control Channel).

19. A communication device for use in a wireless communication system, the communication device comprising:
a first radio based on LIE radio technology or LTE-Advanced radio technology and a second radio based on another radio technology;
a control circuit coupled to the first and second radios;
a processor installed in the control circuit;
a memory installed in the control circuit and coupled to the processor;
wherein the processor is configured to execute a program code stored in memory to perform a coexistence interference avoidance in the communication device by:
establishing a RRC (Radio Resource Control) connection between an eNB (evolved Node B) and a UE (user equipment); and
determining a presence of in-device coexistence interference in the UE based on a downlink transport block error rate (TBER) in a LTE or LIE-Advanced radio technology.
